(19) United States
(12) Patent Application Publication
(10) Pub. No.: US 2003/0232193 A1
(43) Pub. Date: Dec. 18, 2003

(54) Dry film resist and printed circuit board producing method

(75) Inventor: Masayuki Iwasaki, Fujinomiya-shi (JP)

Correspondence Address: YOUNG & THOMPSON, 745 SOUTH 23RD STREET 2ND FLOOR, ARLINGTON, VA, 22202

(73) Assignee: FUJI PHOTO FILM CO., LTD., MINAMI-ASHIGARA-SHI (JP)

(21) Appl. No.: 10/458,195

(22) Filed: Jun. 11, 2003

(30) Foreign Application Priority Data
Jun. 12, 2002 (JP) 2002-171902

(51) Int. Cl. B32B 7/12

(52) U.S. Cl. 428/354

(57) ABSTRACT

A dry film resist has a support. First and second photo resist layers are disposed on the support, developable in alkaline development, and sensitive to active energy rays. The first photo resist layer is overlaid on the support. The second photo resist layer is overlaid on the first photo resist by application in a state of water dispersion emulsion. A protective film is overlaid on the second photo resist layer in a peelable manner. The first photo resist layer includes first binder, soluble in aqueous solution of alkali, and obtained by solution polymerization, and also includes polyfunctional monomer and active energy ray initiator. The second photo resist layer is formed after drying of coating liquid constituting the first photo resist layer, and includes second binder of emulsion, soluble in aqueous solution of alkali, and obtained by emulsion polymerization. Polyfunctional monomer and active energy ray initiator are mixed in a form of water dispersion with the second binder.

### BACKGROUND OF THE INVENTION

1. Field of the Invention

The present invention relates to a dry film resist and a printed circuit board producing method. More particularly, the present invention relates to a dry film resist which can be produced easily and efficiently and also with high precision required for a high resolution in a pattern, and a printed circuit board producing method in which the dry film resist is used.

2. Description Related to the Prior Art

There has been a recent technical tendency in that density of a printed circuit board becomes higher and higher according to reduction in sizes of electronic instruments and rise in their variety in the performance. For example, circuits of conductors come to have highly finer lines and a higher degree of multi-layer structures. Through holes including via holes in build-up boards come to have smaller diameters. Density in the mounting comes higher because of small chips of parts mounted on the board surface.

There are known examples of etching photo resists for printed circuit boards, including a dry film resist and a liquid resist. To produce a printed circuit board, a producing method is used in general. At first, holes are formed in a plate. The plate or panel is plated with copper to obtain a copper-plated laminate plate. Then the dry film resist is laminated on the plate, before a pattern of an etching resist is formed by an exposure with a mask or alkaline development. The etching resist is etched, finally to obtain a printed circuit board with copper through holes. There is expectation of further highness of the resolution in the patterning. One of the effective methods for the purpose is to reducing the thickness of a photo resist layer. However, it is very difficult to keep tightness in attachment of the resist to the copper surface, and at the same time to ensure strength of the tent specifically when the photo resist layer with a thickness of 20 microns or less overlaid on the dry film resist.

Also, there is a suggestion of laminating the dry film resist in a vacuum condition, entering the photo resist layer of the dry film resist to the inside of holes, to form the through holes with a small-diameter land. However, there are shortcomings in that a device for the lamination must have a large scale with a high cost. A speed of the lamination is likely to be very low, to lower the efficiency and productivity of the dry film resist.

In addition, a hole ink method is known, in which the etching resist is entered into the through holes by a technique of the screen printing, roll coating or the like, and dried or hardened. Unwanted part of the resist on the surface is polished and removed, before a pattern is formed on required pattern positions including the hole-closed portions by use of screen printing ink or the dry film resist. However, it is difficult to form a pattern with precision of 150 microns or less, because the screen printing is likely to leave a corrugated or zigzag shape of lines after the use of a meshed form of the screen. It is conceivable to use the dry film resist further for entry into the through holes. However, additional steps are required for entry into the holes and for forming the pattern with the dry film resist. This will lower the productivity.

Also, an electrodeposition resist method is known, in which a coating of a photo resist is applied according to electrodeposition as a method of forming a pattern to a copper-plated laminate plate at a high resolution. There are examples of electrodeposition resists including a negative type and a positive type. The negative type is hardened in response to application of active energy rays. The positive type becomes soluble to aqueous solution of alkali or other suitable liquid in response to application of active energy rays. According to the negative type of photo resist as liquid resist or electrodeposition resist, it is necessary to apply ultraviolet rays to eliminate the etching resist from the through holes. However, it is excessively difficult to apply the ultraviolet rays completely to the etching resist on the an inner surface of the through holes. A problem arises in occurrence of pinholes after etching. According to the positive type of photo resist, the ultraviolet rays are applied to portions to be etched other than the plated through holes. However, there are guide hole and reference holes among the through holes but not requiring the plating. It is necessary to apply the ultraviolet rays to eliminate the etching resist from the guide holes and reference holes at the time of development. However, it is excessively difficult to apply the ultraviolet rays to the etching resist on the an inner surface of the guide holes and reference holes. A problem arises in unwanted remainder of copper plating on the hole surface.

JP-A 8-054732 discloses the dry film resist having two photo resist layers. A first one of the photo resist layers close to the substrate is provided with higher fluidity than a second one of the photo resist layers farther from the substrate. When the photo resist layers are melted into the through holes, the through holes can be closed with a highly reliable tent as a known technique. However, no suggestion is disclosed in the document for overlaying the photo resist layers. According to the prior art, there is no easy selection of a solvent which would be used in an upper layer, and could safely allow overlaying of the upper layer without dissolving a lower layer.

Furthermore, there are various documents suggesting the photo resist layers in the dry film resist. U.S. Pat. No. 3,157,505 (corresponding to JP-A 37-001306) discloses two photo polymerizable layers which are different in the sensitivity and overlaid on one another, to form a printing plate of the letterpress printing in a trapezoidal shape. Also, U.S. Pat. No. 4,337,308 (corresponding to JP-B 61-031855), U.S. Pat. No. 4,349,620 (corresponding to JP-A 56-025732), JP-A 57-042043, JP-A 58-136027, and JP-A 61-080236 disclose the dry film resist having two photosensitive layers which are provided with different performances for the purpose of multiple effects. However, one of the documents only suggests a method of forming an upper layer of the photo resist layers with solvent which does not dissolve a lower layer. Another of the documents suggests a method of originally forming the photo resist layers on two separate supports, and then overlaying the photo resist layers on one another. There is no solution of the problem in the low productivity in the known techniques.

### SUMMARY OF THE INVENTION

In view of the foregoing problems, an object of the present invention is to provide a dry film resist which can be produced easily and efficiently and also with high precision required for a high resolution in a pattern, and a printed circuit board producing method in which the dry film resist is used.

In order to achieve the above and other objects and advantages of this invention, a dry film resist includes a support. First and second photo resist layers are disposed on the support, developable in alkaline development, and sensitive to active energy rays. The first photo resist layer is overlaid on the support. The second photo resist layer is overlaid on the first photo resist by application in a state of water dispersion emulsion. A protective film is overlaid on the second photo resist layer in a peelable manner.

The second photo resist layer has a higher fluidity than the first photo resist layer at a time of heating for lamination to a substrate.

Viscosity of the second photo resist layer is smaller by at least 10% than viscosity of the first photo resist layer at the heating time for the lamination.

The first and second photo resist layers have viscosity of 10⁴-10⁶ Pa.s at 60-120° C.

The support has a thickness of 5-150 microns, the first photo resist layer has a thickness of 1-100 microns, and the second photo resist layer has a thickness of 3-100 microns.

The first photo resist layer includes first binder, soluble in aqueous solution of alkali, and obtained by solution polymerization, and also includes first polyfunctional monomer and first active energy ray initiator. The second photo resist layer is formed after drying of coating liquid constituting the first photo resist layer, and includes second binder of emulsion, soluble in aqueous solution of alkali, and obtained by emulsion polymerization. Second polyfunctional monomer and second active energy ray initiator are mixed in a form of water dispersion with the second binder.

Each of the first and second polyfunctional monomers contains two or more ethylenically unsaturated bonds, and is photo polymerizable in response to the active energy rays.

Each of the first and second active energy ray initiators includes at least one of derivative of halogenated hydrocarbon, ketone compound, ketoxime compound, organic peroxide, thio compound, hexaaryl biimidazole, aromatic onium salt, and ketoxime ether.

The second photo resist layer further includes emulsifier for the emulsion polymerization of the second binder.

The emulsifier includes at least one of anion emulsifier, nonionic emulsifier, and polymerizable emulsifier that has a polymerizable functional group.

According to another aspect of the invention, a printed circuit board producing method in which the dry film resist is used is provided. A laminate plate is supplied, including an insulation substrate, plural through holes formed in the insulation substrate, and a copper plating layer overlaid on the insulation substrate. The protective film is peeled from the dry film resist. The dry film resist and the laminate plate are laminated and heated by opposing the second photo resist layer of the dry film resist to the laminate plate. The active energy rays are applied to the dry film resist according to pattern information, the pattern information being associated with a portion for being covered among the through holes and a portion for forming a circuit pattern among the through holes, so as to expose a first portion in the first and second photo resist layers, the first portion being hardened and becoming insoluble to alkali. A portion of the first and second photo resist layers different from the first portion is eliminated from the laminate plate by dissolution in aqueous solution of weak alkali. The copper plating layer is eliminated from a periphery of the first portion in the insulation substrate by etching. The first portion is eliminated from the insulation substrate by dissolution in aqueous solution of strong alkali, to obtain a covered portion and the circuit pattern of the copper plating layer among the through holes.

The active energy rays are ultraviolet or visible. In the applying step, a photo mask is used through which the active energy rays are applied, the photo mask has an aperture for constituting the pattern information to form the first portion in the dry film resist.

In another preferred embodiment, the active energy rays are laser light, and in the applying step, the laser light is caused to scan the dry film resist according to the pattern information.

### BRIEF DESCRIPTION OF THE DRAWINGS

The above objects and advantages of the present invention will become more apparent from the following detailed description when read in connection with the accompanying drawings, in which:

FIG. 1 is an explanatory view in section, illustrating a dry film resist according to the prior art;

FIG. 2 is an explanatory view in section, illustrating a dry film resist according to the present invention;

FIG. 3 is an explanatory view, partially broken, illustrating a thickness reducing state upon lamination of the known dry film resist on a laminate plate;

FIG. 4 is an explanatory view, partially broken, illustrating a thickness reducing state upon lamination of the dry film resist of the invention on the laminate plate;

FIG. 5A is an explanatory view in section, illustrating a first step of a printed circuit board producing process;

FIG. 5B is an explanatory view in section, illustrating a step of laminating the dry film resist on the laminate plate;

FIG. 5C is an explanatory view in section, illustrating a step of an exposure with a photo mask;

FIG. 5D is an explanatory view in section, illustrating a step of developing the pattern;

FIG. 5E is an explanatory view in section, illustrating a step of etching the unexposed copper; and

FIG. 5F is an explanatory view in section, illustrating a step of peeling photo resist layers.

### DETAILED DESCRIPTION OF THE PREFERRED EMBODIMENT(S) OF THE PRESENT INVENTION

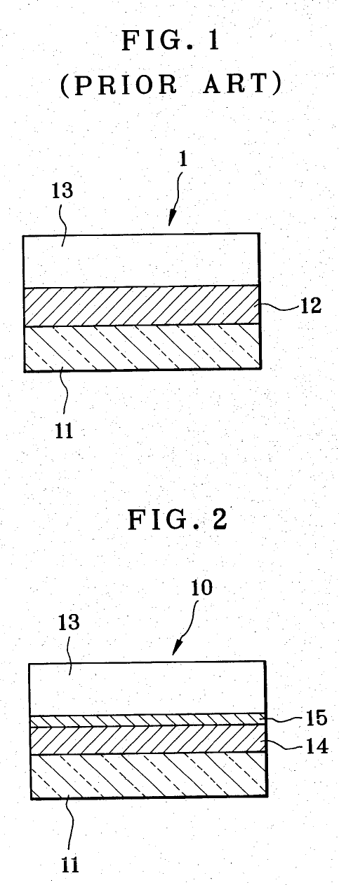

According to the present invention, a dry film resist includes a support, and a first photo resist layer, applied to the support and dried, and sensitive to the active energy rays and developable in alkaline development. A second photo resist layer is applied to the support in a state of emulsion of water dispersion, and dried, and sensitive to the active energy rays and developable in alkaline development. A protective film is overlaid on the second photo resist layer in a peelable manner. Fluidity of the second photo resist layer in heating for laminating the dry film resist on to a substrate is higher than fluidity of the first photo resist layer. In FIG. 1, a single-layer structure of a dry film resist according to the prior art is illustrated. In FIG. 2, the two-layer structure of the dry film resist according to the present invention is illustrated.

Each of compositions for the first and second photo resist layers is constituted by polymer binder, polyfunctional monomer, and active energy ray initiator for photo polymerization, the polymer binder being insoluble to water, soluble to aqueous solution of alkali, and including a carboxylic acid group. In laminating the dry film resist to the surface of the copper-plated laminate plate, viscosity of the second photo resist layer in the heating for the laminating is smaller by at least 10% than viscosity of the first photo resist layer.

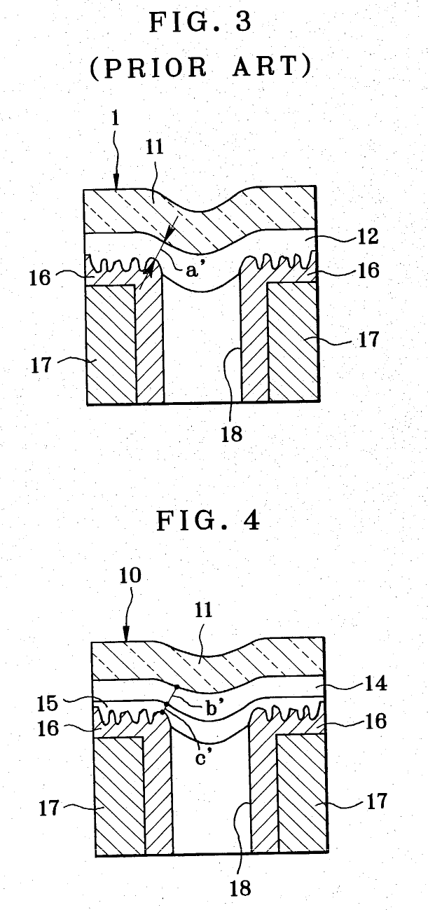

Note that the highness of the fluidity is referred to. The dry film resist after peeling the protective film is attached and laminated to the copper-plated laminate plate having the through holes. In the attaching step, heat is applied at 60-120° C. in such a range as not to harden the photo resist layers thermally. The photo resist layers are softened and come to have low viscosity, to become stuck on the laminate plate by tightly following an uneven shape with protrusion and retraction. Also, the softened part of the photo resist layers easily flows into the through holes to enclose the inside of intended part of the through holes. In contrast, lowness of the fluidity is referred to. In laminating the dry film resist to the copper-plated laminate plate, viscosity of the photo resist layers is relatively high particularly on the periphery of each edge of the through holes. Referring to FIGS. 3 and 4, the thicknesses of the photo resist layers comes to have a relationship of b′+c′>a′.

According to the single-layer structure of the prior art, highness in the fluidity for the purpose of tightening attachment to the substrate results in reducing the thickness of the photo resist layer in the vicinity of the through holes. However, the two-layer structure of the present invention can have the first photo resist layer with lower fluidity than the second photo resist layer. The thickness in the film can be kept from reduction in the vicinity of the through holes. At the same time, fluidity of the second photo resist layer can be determined high to tighten attachment to the substrate.

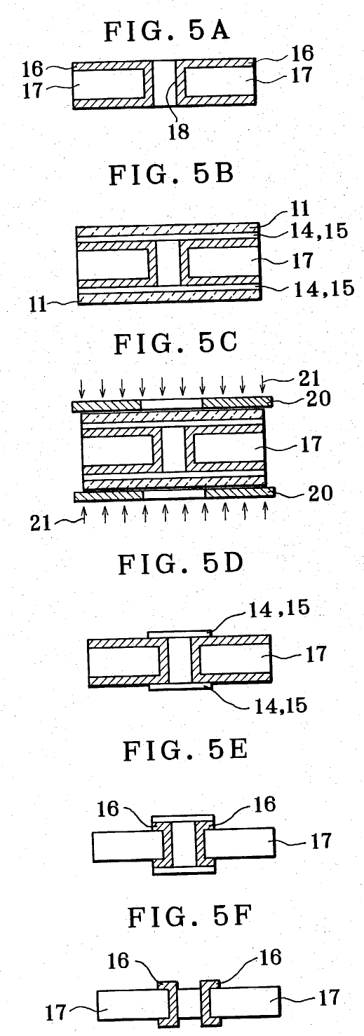

A printed circuit board producing method of the present invention is illustrated in FIGS. 5A-5F. In FIG. 5A, a laminate plate includes an insulation substrate having through holes, and a copper plating layer deposited on the insulation substrate on a whole surface thereof. In FIG. 5B, after peeling the protective film from the dry film resist, the dry film resist is overlaid on the laminate plate with heat applied thereto to cover the laminate plate entirely with the dry film resist. In FIG. 5C, active energy rays are applied to one predetermined portion of the through holes in the laminate plate to harden the photo resist layers in the one predetermined portion which is designated for being covered with the resist or designated for forming a wiring pattern. Note that the active energy rays are ultraviolet rays which are combined with a photo mask, or laser light which is scanned according to pattern information. In FIG. 5D, a photo resist pattern is developed by eliminating an unexposed portion of the photo resist layers by use of aqueous solution of weak alkali. In FIG. 5E, the laminate plate is etched to eliminate an uncovered portion of the copper plating layer from the insulation substrate. In FIG. 5F, the dry film resist is peeled totally by dissolving the developed photo resist pattern by use of aqueous solution of strong alkali. In the present method, the dry film resist in use has a high strength of the tent, and can be stuck on the substrate very tightly. A high-density circuit board can be produced at a large yield even with a structure of fine patterning and through holes with a very small diameter.

### EXAMPLES

In dry film resist used in the invention, compositions for the first and second photo resist layers respectively include polymer binder being insoluble to water, soluble to aqueous solution of alkali, and including a carboxylic acid group. Polyfunctional monomer and active energy ray initiator for photo polymerization are added to the polymer binder. An example of the polyfunctional monomer is polymerizable compound having two or more acrylate groups. If desired, it is further preferable to add thermal polymerization inhibitor, plasticizer, leuco dye, colorant, adhesion promoter, anti-foaming agent, leveling agent, and anti-settling agent, which are known in the art.

Fluidity of compositions of the first and second photo resist layers heated in the dry film resist can be controlled by a composition and molecular weight of binder in copolymerization, and types and amounts of polyfunctional monomers. The fluidity of the photo resist layers is higher according to the smallness of the molecular weight of the polymeric binder, the high amount of highly fluid polyfunctional monomers before hardening, and the highness of the total of polyfunctional monomers. The photo resist layers at the time of lamination are heated by heat rolls at 60-120° C. for a period from several seconds to tens of seconds. Preferable viscosity of the photo resist layers in the heating is 10⁴-10⁶ Pa.s.

[Binder]

Binder used in the present invention can be known acrylic and/or methacrylic resin (hereinafter referred to as (meth)acrylic resin) having photo sensitivity and solubility to alkali, and including photosensitive groups for photo polymerization or photo dimerization, such as acryloyl group, methacryloyl group, allyl group, cinnamoyl group. The binder constitutes the compositions for the first and second photo resist layers which are soluble in alkali and sensitive to active energy rays.

It is not absolutely necessary for binder to include a photosensitive group. However, inclusion of a photosensitive group in binder is effective in raising tent strength or raising sensitivity to active energy rays. Density of the photosensitive group being included is preferably in a range of 0.1-5.0 mEq/g, and desirably in a range of 0.3-4.0 mEq/g. Should the density of the photosensitive group be too low, the sensitivity to active energy rays will he very low. Should the density be too high, the stability in preservation and an easily peelable characteristic of the resist will be very small.

The binder used in the photo resist layers is resin soluble to aqueous solution of alkali of pH 10-14, and insoluble to water. Examples of the binder known in the art include acrylic copolymers produced from acrylic monomer having a carboxylic acid group, cellulose ether, and polymers obtained by reaction in which resin having a hydroxy group, for example polyhydroxy ethyl methacrylate, is reacted on maleic anhydride, phthalic anhydride and the like. As acrylic copolymer produced from acrylic monomer having a carboxylic acid group, it is preferable to use copolymers produced by copolymerizing monomer having a carboxylic acid group with other monomer capable of copolymerization.

Examples of monomers including a carboxylic acid group are (meth)acrylic acid, vinyl benzoate, maleic acid, maleic anhydride, itaconic acid, itaconic anhydride, crotonic acid, cinnamic acid, and acrylic acid dimer. Also, it is possible to use an addition compound obtained after monomer having a hydroxy group, for example 2-hydroxy ethyl (meth)acrylate is reacted with cyclic anhydride, such as maleic anhydride and phthalic anhydride. Among the monomers, (meth)acrylic acid is preferable in particular.

Examples of the other copolymerizable monomers are ethylenically unsaturated monomers not having a carboxylic acid group. Among those, monomers lacking chemical reactivity on a carboxylic acid group are desirable. Such examples are acrylate esters, methacrylate esters, crotonate esters, vinyl esters, maleate diesters, fumarate diesters, itaconate diesters, (meth)acrylonitriles, (meth)acrylamides, styrenes, and vinyl ethers. Specific compounds of those examples are hereinafter described.

Examples of acrylate esters include methyl acrylate, ethyl acrylate, n-propyl acrylate, isopropyl acrylate, n-butyl acrylate, isobutyl acrylate, tert-butyl acrylate, n-hexyl acrylate, 2-ethyl hexyl acrylate, acetoxy ethyl acrylate, phenyl acrylate, 2-hydroxy ethyl acrylate, 2-methoxy ethyl acrylate, 2-ethoxy ethyl acrylate, 2-(2-methoxy ethoxy) ethyl acrylate, cyclohexyl acrylate, and benzyl acrylate.

Examples of methacrylate esters include methyl methacrylate, ethyl methacrylate, n-propyl methacrylate, isopropyl methacrylate, n-butyl methacrylate, isobutyl methacrylate, tert-butyl methacrylate, n-hexyl methacrylate, 2-ethyl hexyl methacrylate, acetoxy ethyl methacrylate, phenyl methacrylate, 2-hydroxy ethyl methacrylate, 2-methoxy ethyl methacrylate, 2-ethoxy ethyl methacrylate, 2-(2-methoxy ethoxy) ethyl methacrylate, cyclohexyl methacrylate, and benzyl methacrylate.

Examples of crotonate esters include butyl crotonate and hexyl crotonate. Examples of vinyl esters include vinyl acetate, vinyl propionate, vinyl butylate, vinyl methoxy acetate, and vinyl benzoate.

Examples of maleate diesters include dimethyl maleate, diethyl maleate, and dibutyl maleate. Examples of fumarate diesters include dimethyl fumarate, diethyl fumarate, and dibutyl fumarate. Examples of itaconate diesters include dimethyl itaconate, diethyl itaconate, and dibutyl itaconate.

Examples of acrylamides include acrylamide, methyl acrylamide, ethyl acrylamide, propyl acrylamide, n-butyl acrylamide, tert-butyl acrylamide, cyclohexyl acrylamide, 2-methoxy ethyl acrylamide, dimethyl acrylamide, diethyl acrylamide, phenyl acrylamide, and benzyl acrylamide.

Examples of methacrylamides include methacrylamide, methyl methacrylamide, ethyl methacrylamide, propyl methacrylamide, n-butyl methacrylamide, tert-butyl methacrylamide, cyclohexyl methacrylamide, 2-methoxy ethyl methacrylamide, dimethyl methacrylamide, diethyl methacrylamide, phenyl methacrylamide, and benzyl methacrylamide.

Examples of vinyl ethers include methyl vinyl ether, butyl vinyl ether, hexyl vinyl ether, methoxy ethyl vinyl ether, and dimethylamino ethyl vinyl ether. Examples of styrenes include styrene, methyl styrene, dimethyl styrene, trimethyl styrene, ethyl styrene, isopropyl styrene, butyl styrene, methoxy styrene, butoxy styrene, acetoxy styrene, chloro styrene, dichloro styrene, bromo styrene, vinyl methyl benzoate, and α-methyl styrene. Examples of other usable compounds include maleimide, vinyl pyridine, vinyl pyrrolidone, and vinyl carbazole.

Note that, among those compounds, only a single monomer may be used. Also, two or more monomers can be used in combination at one time. Preferable examples of other monomers include methyl acrylate, methyl methacrylate, ethyl acrylate, ethyl methacrylate, butyl acrylate, butyl methacrylate, benzyl methacrylate, styrene, methyl styrene, α-methyl styrene, chloro styrene, bromo styrene, chloro methyl styrene, and hydroxy styrene.

Acrylic copolymer according to monomer including a carboxylic acid group is obtained by copolymerizing the monomers according to known techniques of polymerization. For example, solution polymerization is used, in which monomer is dissolved in a suitable solvent, to which radical polymerization initiator is added to effect polymerization in the solution. Note that it is also possible to use emulsion polymerization, in which monomer is dispersed in aqueous medium, and polymerized in the dispersed state.

Solvent suitable for the solution polymerization can be selected in consideration of monomers in use and the solubility of the copolymer to be produced. Preferable examples of solvents include methanol, ethanol, propanol, isopropanol, 1-methoxy-2-propanol, acetone, methyl ethyl ketone, methyl isobutyl ketone, methoxy propyl acetate, ethyl lactate, ethyl acetate, acetonitrile, tetrahydrofuran, dimethyl formamide, chloroform, toluene, and mixtures of any of those. Examples of polymerization initiators include azo compounds, peroxides, and persulfates. Examples of azo compounds are 2,2′-azo bis(isobutyl nitrile) (i.e. AIBN), and 2,2′-azo bis(2,4′-dimethyl valeronitrile). An example of peroxide is benzoyl peroxide. A composition ratio of a repeating unit of the carboxylic acid group in the acrylic copolymer produced from monomer including a carboxylic acid group is 1-60 mole% relative to repeating units of all monomers in the copolymer, and preferably 5-50 mole %, and desirably 10-40 mole %. Should the ratio of the repeating unit of the carboxylic acid group be less than 1 mole %, a developable characteristic to aqueous solution of alkali will be too low. Should the ratio be more than 60 mole %, resistance to eliminating liquid for the hardened insulation layer after the baking will be too low.

Preferable examples of binders usable in the compositions for the photo resist layers can be alkali-soluble resins disclosed in U.S. Pat. No. 5,030,548 (corresponding to JP-B 8-020733), JP-B 2706858 (corresponding to JP-A 5-036581), JP-B 2756623 (corresponding to JP-A 5-241340), and JP-A 10-161309.

A molecular weight of acrylic copolymer produced from monomer including a carboxylic acid can be adjusted as desired. The acrylic copolymer can have weight-average molecular weight of preferably 1,000-200,000, and desirably 4,000-100,000. Should the weight-average molecular weight be less than 1,000, the strength of the film will be too low. Manufacture of the film will in a stable state will be too difficult. Should the weight-average molecular weight be more than 200,000, a characteristic of being developable will be too low.

Particularly preferable examples of binders are as follows.

Copolymer of methyl methacrylate and methacylic acid, with composition ratios of 70-85 mole % and 30-15 mole %, and weight-average molecular weight of 50,000-140,000;

Copolymer of benzyl methacrylate and methacrylic acid, with composition ratios of 65-75 mole % and 35-25 mole %, and weight-average molecular weight of 30,000-150,000;

Copolymer of styrene and maleic acid, with composition ratios of 50-70 mole % and 50-30 mole %, and weight-average molecular weight of 10,000-200,000;

Copolymer of 2-hydroxy ethyl methacrylate, benzyl methacrylate, and methacrylic acid, with composition ratios of 10-30 mole %, 40-60 mole % and 30-10 mole %, and weight-average molecular weight of 10,000-200,000;

Copolymer of methacrylic acid, methyl methacrylate, ethyl acrylate, and benzyl methacrylate, with composition ratios of 14-30 mole %, 20-70 mole %, 3-30 mole % and 3-30 mole %, and weight-average molecular weight of 30,000-200,000;

Mixture of any of the foregoing binders and copolymer of styrene and (meth)acrylic acid, the copolymer being with composition ratios of 15-60 mole % and 40-85 mole %, and weight-average molecular weight of 1,000-100,000.

Any of those examples of binders is added in a range of 30-90 wt. % relative to the photo resist composition, and preferably 40-80 wt. %, and desirably 45-65 wt. %. Should the ratio of the binder be lower than the lower limit of the preferable range, a developable characteristic in the alkaline development will be too low. Tightness in attachment to the copper plating layer will be too low. Should the ratio of the binder be higher than the upper limit of the preferable range, stability relative to the development time will be too low, and strength of the hardened film will be too low.

[Polyfunctional Monomers]

Polyfunctional monomer is a compound having at least two ethylenically unsaturated bonds and being capable of addition polymerization. The compound is polymerized in response to active energy rays without loss of solubility in the binder to aqueous solution of alkali. The polyfunctional monomer reduces solubility of the coating to aqueous solution of alkali, the coating including the binder.

Polyfunctional monomers used in the present invention are described. Compounds having two or more ethylene-terminated unsaturated bonds per one molecule can be a polyfunctional monomer. Examples of structures of such compounds are monomer, prepolymer such as diner, trimer and oligomer, or mixture of any of those, or copolymer of any of those. Examples of monomers and copolymers thereof include esters of unsaturated carboxylic acid and aliphatic polyvalent alcohol compounds, and amides of unsaturated carboxylic acid and aliphatic polyvalent amine compounds. Examples of unsaturated carboxylic acids are acrylic acid, methacrylic acid, itaconic acid, crotonic acid, isocrotonic acid, and maleic acid.

Examples of monomers or esters produced by aliphatic polyvalent alcohol compounds and unsaturated carboxylic acids are described. Examples of acrylate esters include ethylene glycol diacrylate, triethylene glycol diacrylate, 1,3-butane diol diacrylate, tetra methylene glycol diacrylate, propylene glycol diacrylate, neopentyl glycol diacrylate, trimethylol propane triacrylate, trimethylol propane tri(acryloyl oxy propyl) ether, trimethylol ethane triacrylate, hexane diol diacrylate, 1,4-cyclohexane diol diacrylate, tetra ethylene glycol diacrylate, penta erythritol diacrylate, penta erythritol triacrylate, penta erythritol tetra acrylate, dipentaerythritol diacrylate, dipentaerythritol hexa acrylate, sorbitol triacrylate, sorbitol tetra acrylate, sorbitol penta acrylate, sorbitol hexa acrylate, tri(acryloyl oxy ethyl) isocyanurate, and polyester acrylate oligomer.

Examples of methacrylate esters include tetra methylene glycol dimethacrylate, triethylene glycol dimethacrylate, neopentyl glycol dimethacrylate trimetylolpropane trimethacrylate, trimetylolethane trimethacrylate, ethylene glycol dimethacrylate, 1,3-butane diol dimethacrylate, hexane diol dimethacrylate, penta erythritol dimethacrylate, penta erythritol trimethacrylate, penta erythritol tetra methacrylate, dipentaerythritol dimethacrylate, dipentaerythritol hexa methacrylate, sorbitol trimethacrylate, sorbitol tetra methacrylate, bis[p-(3-methacryl oxy-2-hydroxy propoxy) phenyl]dimethyl methane, and bis[p-(methacryl oxy ethoxy) phenyl]dimethyl methane.

Examples of itaconate esters include ethylene glycol diitaconate, propylene glycol diitaconate, 1,3-butane diol diitaconate, 1,4-butane diol diitaconate, tetra methylene glycol diitaconate, penta erythritol diitaconate, and sorbitol tetra itaconate.

Examples of crotonate esters include ethylene glycol dicrotonate, tetra methylene glycol dicrotonate, penta erythritol dicrotonate, and sorbitol tetra crotonate. Examples of isocrotonate esters include ethylene glycol diisocrotonate, penta erythritol diisocrotonate, and sorbitol tetra isocrotonate.

Examples of maleate esters include ethylene glycol dimaleate, triethylene glycol dimaleate, penta erythritol dimaleate, and sorbitol tetra maleate. Furthermore, mixture with the above-described ester monomers can be used. Examples of monomers as amides produced by aliphatic polyvalent amine compounds and unsaturated carboxylic acids include methylene bis-acrylamide, methylene bis-methacrylamide, 1,6-hexamethylene bis-acrylamide, 1,6-hexamethylene bis-methacrylamide, diethylene triamine tris-acrylamide, xylylene bis-acrylamide, and xylylene bis-methacrylamide.

Another example is a vinyl urethane compound disclosed in JP-B 48-041708, which includes two or more polymerizable vinyl groups, and which is obtained after a vinyl monomer of the following formula having a hydroxy group is added to poly isocyanate compound having two or more isocyanate groups per one molecule.

CH₂═C(R²)COOCH₂CH(R³)OH

wherein R² and R³ represent a hydrogen atom or methyl group.

Also, polyfunctional acrylates and methacrylates are preferable, including urethane acrylates disclosed in U.S. Pat. No. 4,038,257 (corresponding to JP-A 51-037193), polyester acrylates disclosed in JP-A 48-064183, JP-B 49-043191, and JP-B 52-030490 (corresponding to JP-A 48-096515), and epoxy acrylates obtained by reaction of epoxy resin and (meth)acrylic acid. It is also possible to use photo-setting monomer and oligomer disclosed in Journal of the Adhesion Society of Japan (Nihon Setchaku Kyokai Shi) Volume 20, No.7, pages 300-308 (1984). Compounds which have at least one ethylenically unsaturated bond and are capable of addition polymerization can be used singularly or in combination of two or more compounds. Any of those examples of polyfunctional monomers is added in a range of 5-60 wt. % relative to the photo resist composition, and preferably 10-50 wt. %, and desirably 20-45 wt. %. Should the ratio of the polyfunctional monomer be lower than the lower limit of the range, strength of the hardened film will be too low. Should the ratio of the polyfunctional monomer be higher than the upper limit of the range, tightness in attachment to the laminate plate will be too low.

[Active Energy Ray Initiators for Photo Polymerization]

Active energy ray initiator operates for substantially starting photo polymerization of polyfunctional monomer. All compounds having at least one ethylenically unsaturated bond can be used as active energy ray initiator to initiate polymerization. In particular, compounds are preferable if sensitive to violet rays or rays in an ultraviolet region. Also, active energy initiator in the present invention may be activator for producing active radical by certain action with photo-excited sensitizer. Preferable examples of active energy ray initiators for use in the present invention include derivatives of halogenated hydrocarbons, ketone compounds, ketoxime compounds, organic peroxides, thio compounds, hexaaryl biimidazoles, aromatic onium salts, and ketoxime ethers.

Among those examples, active energy ray initiators constituted by halogenated hydrocarbons having a triazine structure, particular ketoxime compounds, or hexaaryl biimidazoles are specifically preferable because of high sensitivity, high suitability for preservation, good tightness in application of each layer to the substrate, or other good quality.

Examples of halogenated hydrocarbon compounds having a triazine structure are disclosed by Wakabayashi et al. in Bull. Chem. Soc. Japan, 42, 2924 (1969), such as 2-phenyl-4,6-bis(trichloro methyl)-s-triazine, 2-(p-chloro phenyl)-4,6-bis(trichloro methyl)-s-triazine, 2-(p-tolyl)-4,6-bis(trichloro methyl)-s-triazine, 2-(p-methoxy phenyl)-4,6-bis(trichloro methyl)-s-triazine, 2-(2′,4′-dichloro phenyl)-4,6-bis(trichloro methyl)-s-triazine, 2,4,6-tris(trichloro methyl)-s-triazine, 2-methyl-4,6-bis(trichloro methyl)-s-triazine, 2-n-nonyl-4,6-bis(trichloro methyl)-s-triazine, and 2-(α,α,β-trichloro ethyl)-4,6-bis(trichloro methyl)-s-triazine.

Compounds disclosed in GB 1 388 492 are also preferable, including 2-styryl-4,6-bis(trichloro methyl)-s-triazine, 2-(p-methyl styryl)-4,6-bis(trichloro methyl)-s-triazine, 2-(p-methoxy styryl)-4,6-bis(trichloro methyl)-s-triazine, and 2-(p-methoxy styryl)-4-amino-6-trichloro methyl-s-triazine.

Compounds disclosed in GB 1 602 903 (corresponding to JP-A 53-133428) are also preferable, including 2-(4-methoxy naphtho-1-yl)-4,6-bis(trichloro methyl)-s-triazine, 2-(4-ethoxy naphtho-1-yl)-4,6-bis(trichloro methyl)-s-triazine, 2-[4-(2-ethoxy ethyl)-naphtho-1-yl]-4,6-bis(trichloro methyl)-s-triazine, 2-(4,7-dimethoxy naphtho-1-yl)-4,6-bis(trichloro methyl)-s-triazine, and 2-(acenaphtho-5-yl)-4,6-bis(trichloro methyl)-s-triazine.

Compounds disclosed in U.S. Pat. No. 4,619,998 (corresponding to DE-A 3 337 024) are also preferable, including 2-(4-styryl phenyl)-4,6-bis(trichloro methyl)-s-triazine, 2-(4-p-methoxy styryl phenyl)-4,6-bis(trichloro methyl)-s-triazine, 2-(1-naphthyl vinylene phenyl)-4,6-bis(trichloro methyl)-s-triazine, 2-chloro styryl phenyl-4,6-bis(trichloro methyl)-s-triazine, 2-(4-thiophene-2-vinylene phenyl)-4,6-bis(trichloro methyl)-s-triazine, 2-(4-thiophene-3-vinylene phenyl)-4,6-bis(trichloro methyl)-s-triazine, 2-(4-furan-2-vinylene phenyl)-4,6-bis(trichloro methyl)-s-triazine, and 2-(4-benzofuran-2-vinylene phenyl)-4,6-bis(trichloro methyl)-s-triazine.

Furthermore, compounds disclosed by F. C. Schaefer et al. in J. Org. Chem. 29, 1527 (1964) are also preferable, including 2-methyl-4,6-bis(tribromo methyl)-s-triazine, 2,4,6-tris(tribromo methyl)-s-triazine, 2,4,6-tris(dibromo methyl)-s-triazine, 2-amino-4-methyl-6-tribromo methyl-s-triazine, and 2-methoxy-4-methyl-6-trichloro methyl-s-triazine.

Also, compounds disclosed in U.S. Pat. No. 4,772,534 (corresponding to JP-A 62-058241) are preferable, such as: 2-(4-phenyl acetylene phenyl)-4,6-bis(trichloro methyl)-s-triazine, 2-(4-naphthyl-1-acetylene phenyl)-4,6-bis(trichloro methyl)-s-triazine, 2-(4-p-tolyl acetylene phenyl)-4,6-bis(trichloro methyl)-s-triazine, 2-(4-p-methoxy phenyl acetylene phenyl)-4,6-bis(trichloro methyl)-s-triazine, 2-(4-p-isopropyl phenyl acetylene phenyl)-4,6-bis(trichloro methyl)-s-triazine, and 2-(4-p-ethyl phenyl acetylene phenyl)-4,6-bis(trichloro methyl)-s-triazine.

Furthermore, compounds disclosed in EP-A 0 563 925 (corresponding to JP-A 5-281728) are preferable, such as: 2-(4-trifluoro methyl phenyl)-4,6-bis(trichloro methyl)-s-triazine, 2-(2,6-difluoro phenyl)-4,6-bis(trichloro methyl)-s-triazine, 2-(2,6-dichloro phenyl)-4,6-bis(trichloro methyl)-s-triazine, and 2-(2,6-dibromo phenyl)-4,6-bis(trichloro methyl)-s-triazine. JP-A 5-034920 also discloses a preferable compound: 2,4-bis(trichloro methyl)-6-[4-(N,N-diethoxy carbonyl methyl amino)-3-bromo phenyl]-s-triazine.

JP-A 2001-305734 discloses compounds of the electron transferring initiation system. All of those compounds can be used preferably. Ketoxime compounds usable preferably are expressed in the following formula.

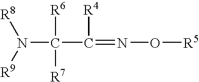

Among the symbols in the formula:

R⁴ and R⁵ express a hydrocarbon group or a heterocyclic group which may be equal to or different from one another, and which may have a substituent and may have an unsaturated bond.

R⁶ and R⁷ express any one of a hydrocarbon group, a heterocyclic group, a hydroxyl group, a substituting oxy group, a mercapto group, and a substituting thio group, which may be equal to or different from one another, and which may have a hydrogen atom or substituent and may have an unsaturated bond.

R⁶ and R⁷ express an alkylene group which is cyclic in a form bonded with one another, which contains 2-8 carbon atoms, and which may contain —O—, —NR⁸—, —O—CO—, —NH—CO—, —S—, and/or —SO₂— in a backbone chain of the cyclic bond.

R⁸ and R⁹ express a hydrocarbon group or a substituting carbonyl group which may have a hydrogen atom or substituent and may have an unsaturated bond.

Preferable compounds include:

p-methoxy phenyl-2-N,N-dimethyl amino propyl ketoxime-O-allyl ether,

p-methyl thiophenyl-2-morpholino propyl ketoxime-O-allyl ether,

p-methyl thiophenyl-2-morpholino propyl ketoxime-O-benzyl ether,

p-methyl thiophenyl-2-morpholino propyl ketoxime-O-n-butyl ether,

p-morpholino phenyl-2-morpholino propyl ketoxime-O-allyl ether,

p-methoxy phenyl-2-morpholino propyl ketoxime-O-n-dodecyl ether,

p-methyl thiophenyl-2-morphol ino propyl ketoxime-O-methoxy ethoxy ethyl ether,

p-methyl thiophenyl-2-morpholino propyl ketoxime-O-p-methoxy carbonyl benzyl ether,

p-methyl thiophenyl-2-morpholino propyl ketoxime-O-methoxy carbonyl methyl ether,

p-methyl thiophenyl-2-morpholino propyl ketoxime-O-ethoxy carbonyl methyl ether,

p-methyl thiophenyl-2-morpholino propyl ketoxime-O-4-butoxy carbonyl butyl ether,

p-methyl thiophenyl-2-morpholino propyl ketoxime-O-2-ethoxy carbonyl ethyl ether,

p-methyl thiophenyl-2-morpholino propyl ketoxime-O-methoxy carbonyl-3-propenyl ether, and

p-methyl thiophenyl-2-morpholino propyl ketoxime-O-benzyloxy carbonyl methyl ether.

Examples of hexaaryl biimidazoles used in the present invention include:

2,2′-bis(o-chloro phenyl)-4,4′,5,5′-tetra phenyl biimidazole,

2,2′-bis(o-bromo phenyl)-4,4′,5,5′-tetra phenyl biimidazole,

2,2′-bis(o,p-dichloro phenyl)-4,4′,5,5′-tetra phenyl biimidazole,

2,2′-bis(o-chloro phenyl)-4,4′,5,5′-tetra(m-methoxy phenyl) biimidazole,

2,2′-bis(o,o′-dichloro phenyl)-4,4′,5,5′-tetra phenyl biimidazole,

2,2′-bis(o-nitro phenyl)-4,4′,5,5′-tetra phenyl biimidazole,

2,2′-bis(o-methyl phenyl)-4,4′,5,5′-tetra phenyl biimidazole,

2,2′-bis(o-trifluoro methyl phenyl)-4,4′,5,5′-tetra phenyl biimidazole.

Those biimidasoles can be produced readily by the methods disclosed in Bull. Chem. Soc. Japan, 33, 565 (1960), and J. Org. Chem., 36 (16) 2262 (1971).

Examples of ketoxime esters are 3-benzoyl oxy imino butane-2-one, 3-acetoxy imino butane-2-one, 3-propionyl oxy imino butane-2-one, 2-acetoxy imino pentane-3-one, 2-acetoxy imino-l-phenyl propane-l-one, 2-benzoyl oxy imino-1-phenyl propane-1-one, 3-p-toluene sulfonyl oxy imino butane-2-one, and 2-ethoxy carbonyl oxy imino-l-phenyl propane-1-one.

One compound or plural compounds of the active energy ray initiators can be used singularly or in combination. Also, it is possible to use plural compounds commonly between different types. An amount of the active energy ray initiator relative to the total of the components is 0.1-50 wt. %, preferably 0.5-30 wt. %, and desirably 1-15 wt. %.

[Sensitizers]

In the case of an example in which visible light or ultraviolet laser is used as active energy rays, it is possible to add sensitizer. Examples of sensitizers include polynuclear aromatic compounds (including pyrene, perylene, and triphenylene), xanthenes (including fluorescein, eosin, erythrosin, rhodamine B, and Rose Bengal), cyanines (including thiacarbocyanine and oxacarbocyanine), merocyanines (including merocyanine and carbo merocyanine), thiazines (including thionine, methylene blue, and toluidine blue), acridines (including acridine orange, chloroflavin, and acriflavin), anthraquinones (including anthraquinone), and squariums (including squarium). Also, the compounds disclosed in JP-A 2001-305734 with the formulae numbered XIV-XVIII can be used preferably as sensitizers because of lack of photo sensitivity to a visible light range of 500 nm or longer.

Any of those examples of sensitizers is added in a range of 0.05-30 wt. % relative to the photo resist composition. The range of addition of the sensitizer is preferably 0.1-20 wt. %, and desirably 0.2-10 wt. %. Should the ratio of the sensitizer be too high, there will occur unwanted deposition of the sensitizer from the photo resist layers in the course of preservation with time. Should the ratio of the sensitizer be too low, sensitivity to the active energy rays will be too low. Productivity will be decrease due to considerable time required for the exposing process.

[Thermal Polymerization Inhibitors]

Thermal polymerization inhibitor can be preferably added to the photo resist composition. Examples of thermal polymerization inhibitors include p-methoxy phenol, hydroquinone, alkyl- or aryl-substituted hydroquinone, t-butyl catechol, pyrogallol, copper(I) chloride, chloranil, naphthylamine, β-naphthol, 2,6-di-t-butyl-p-cresol, pyridine, nitrobenzene, dinitrobenzene, p-toluidine, methylene blue, organic copper compounds, methyl salicylate, and phenothiazine. Any of those examples of thermal polymerization inhibitors is included in a range of 0.001-5 wt. % relative to the polyfunctional monomer. This range of the thermal polymerization inhibitor is preferably 0.01-2 wt. %, and desirably 0.05-1 wt. %. Should the ratio of the thermal polymerization inhibitor be higher than the upper limit of the preferable range, the sensitivity to the active energy rays will be too low. Should the ratio of the thermal polymerization inhibitor be lower, the stability at the time of preservation will be too low to cause low quality.

[Plasticizers]

It is possible to add plasticizer for the purpose of controlling flexibility of the photo resist layers as a film characteristic. Examples of the plasticizers include:

phthalate esters, such as dimethyl phthalate, dibutyl phthalate, diisobutyl phthalate, dioctyl phthalate, octyl capryl phthalate, dicylohexyl phthalate, ditridecyl phthalate, butyl benzyl phthalate, diiosodecyl phthalate, and diaryl phthalate;

glycol esters, such as dimethyl glycol phthalate, ethyl phthalyl ethyl glycolate, methyl phthalyl ethyl glycolate, butyl phthalyl butyl glycolate, and triethylene glycol dicaprylate ester;

phosphate esters, such as tricresyl phosphate and triphenyl phosphate;

aliphatic dibasic esters, such as diisobutyl adipate, dioctyl adipate, dimethyl sebacate, dibutyl sebacate, dioctyl sebacate, and dibutyl malate;

amides, such as benzene sulfonamide, p-toluene sulfonamide, and N-n-butyl acetamide;

other compounds, such as triethyl citrate, glycerin triacetyl ester, and butyl laureate.

Among those, a remarkably preferable plasticizer is p-toluene sulfonamide. Any of those examples of plasticizers is added in a range of 0.1-50 wt. % relative to the composition of the photo resist layers. This range of the plasticizer is preferably 0.5-40 wt. %, and desirably 1-30 wt. %.

[Leuco Dyes]

The compositions of the photo resist layers of the invention may include not only the active energy ray initiators but also leuco dyes, for the purpose of imparting a function of changing the color, namely printout function. Examples of leuco dyes include:

amino triaryl methanes, such as tris-(p-dimethyl amino phenyl)methane, i.e. leuco crystal violet, tris(p-diethyl amino phenyl)methane, tris(p-dimethyl amino-o-methyl phenyl)methane, tris(p-diethyl amino-o-methyl phenyl)methane, bis(p-dibutyl amino phenyl)-[p-(2-cyano ethyl)methyl amino phenyl]methane, bis(p-dimethyl amino phenyl)-2-quinolyl methane, and tris(p-dipropyl amino phenyl)methane;

amino xanthines, such as 3,6-bis(dimethyl amino)-9-phenyl xanthine, and 3-amino-6-dimethyl amino-2-methyl-9-(o-chloro phenyl)xanthine;

amino thio xanthenes, such as 3,6-bis(diethyl amino)-9-(o-ethoxy carbonyl phenyl)thio xanthene, and 3,6-bis(diethyl amino)thio xanthene;

amino-9,10-dihydro acridines, such as 3,6-bis(diethyl amino)-9,10-dihydro-9-phenyl acridine, and 3,6-bis(benzyl amino)-9,10-dihydro-9-methyl acridine;

amino phenoxazines, such as 3,7-bis(diethyl amino)phenoxazine;

amino phenothiazines, such as 3,7-bis(ethyl amino)phenothiazine;

amino dihydro phenazines, such as 3,7-bis(diethyl amino)-5-hexyl-5,10-dihydro phenazine;

amino phenyl methanes, such as bis(p-dimethyl amino phenyl)anilino methane;

amino hydro cinnamic acid compounds, such as 4-amino-4′-dimethyl amino diphenyl amine, and 4-amino-α,β-dicyano hydro methyl cinnamate ester;

hydrazines, such as 1-(2-naphthyl)-2-phenyl hydrazine;

amino-2,3-dihydro anthraquinones, such as 1,4-bis(ethyl amino)-2,3-dihydro anthraquinone;

phenethyl anilines, such as N,N-diethyl-p-phenetyl aniline;

acyl derivatives of leuco dyes containing an alkaline NH-group, such as 10-acetyl-3,7-bis(dimethyl amino)phenothiazine;

leuco compounds which do not have hydrogen for oxidation but which can be oxidated as a color development compound, such as tris(4-diethyl amino-o-tolyl)ethoxy carbonyl menthane;

leuco indigo dyes;

organic amine compounds disclosed in U.S. Pat. Nos. 3,042,515 and 3,042,517 and having a characteristic of being oxidated in the color developing manner, such as 4,4′-ethylene diamine, diphenyl amine, N,N-dimethyl aniline, 4,4′-methylene diamine triphenyl amine, and N-vinyl carbazole.

Among those, a remarkably preferable leuco dye is leuco crystal violet. Any of those examples of leuco dyes is included in a range of 0.01-20 wt. % relative to a solid component including in the composition of the photo resist layers. This range of the leuco dye is preferably 0.05-10 wt. %, and desirably 0.1-5 wt. %.

[Colorants or Dyes]

Dyes can be used in the compositions of the photo resist layers for the purpose of coloring the compositions to facilitate handling, and imparting stability in the preservation. Preferable examples of dyes are brilliant green sulfate, eosin, ethyl violet, erythrosin B, methyl green, crystal violet, basic fuchsin, phenolphthalein, 1,3-diphenyl triazine, alizarin red S, thymolphthalein, methyl violet 2B, quinaldine red, Rose Bengal, metanil yellow, thymolsulfonphthalein, xylenol blue, methyl orange, orange IV, diphenyl thio carbazone, 2,7-dichloro fluorescein, para-methyl red, Congo red, benzopurpurin 4B, α-naphthyl red, Nile blue A, phenanthroline, methyl violet, malachite green oxalate, parafuchsin, Oil Blue #603 (trade name, manufactured by Orient Chemical Industries, Ltd.), rhodamine B, and rhodamine 6G. Among those, a remarkably preferable dye is malachite green oxalate. Any of those examples of dyes is added in a range of 0.001-10 wt. %, preferably 0.01-5 wt. %, and desirably 0.1-2 wt. %.

[Adhesion Promoters]

The compositions of the invention may include also adhesion promoters, for the purpose of raising adhesion to a substrate. Preferable examples of adhesion promoters are disclosed in U.S. Pat. No. 5,328,803 (corresponding to JP-A 5-011439), U.S. Pat. No. 5,300,401 (corresponding to JP-A 5-341532), and JP-A 6-043638. Specifically, it is preferable to use benzimidazole, benzoxazole, benzthiazole, 2-mercapto benzimidazole, 2-mercapto benzoxanol, 2-mercapto benzthiazole, 3-morpholino methyl-1-phenyl triazole-2-thione, 3-morpholino methyl-5-phenyl oxadiazole-2-thione, 5-amino-3-morpholino methyl thiadiazole-2-thione, and 2-mercapto-5-methyl thio thiadiazole. Among those, 3-morpholino methyl-1-phenyl triazole-2-thione is remarkably preferable. Any of those examples of adhesion promoters is added in a range of 0.001-20 wt. %. The range of the addition of the adhesion promoters is preferably 0.01-10 wt. %, and desirably 0.1-5 wt. %.

[Thicknesses of the Photo Resist Layer]

In the dry film resist of the invention, the first photo resist layer on the support has a preferable thickness of 1-20 microns. The second photo resist layer has a preferable thickness of 5-60 microns. However, suitable thickness in combination may be determined in consideration of required precision of the patterning, a diameter of through holes, a thickness of the copper-plated laminate plate, and the like.

[Support]

Material for forming the support may be any film material from which the layers of the photo resist compositions can be peeled. Preferable examples of materials for the support are polyesters, such as polyethylene terephthalate, polyethylene naphthalate, and polycarbonate.

[Production of the 1^{st} Photo Resist Layer]

For the first photo resist layer, components are dissolved in organic solvent, to produce solution in a uniformly adjusted manner. According to a coating method known in the art, the support is coated with the solution, and dried to obtain the layer. Note that it is alternately possible to produce the first photo resist layer in the same method as the second photo resist layer which will be described later.

[Production of the 2^{nd} Photo Resist Layer]

A coating for the second photo resist layer is applied after application and drying of the first photo resist layer. In general, the first photo resist layer has a characteristic soluble to organic solvent. It is unsuitable to use organic solvent for the purpose of overlaying the second photo resist layer on the first photo resist layer. Therefore, a solvent selected for the second photo resist layer should be water or solvent having a characteristic of not dissolving the first photo resist layer. In the present invention, a main component used in the second photo resist layer is emulsion in which material for the photo resist is dispersed in water. Note that it is possible to add organic solvent in a range not lowering stability of dispersion of the emulsion.

The composition of the second photo resist layer of the invention is characterized in including binder and active energy ray curable emulsion, the binder being emulsified by emulsion stabilizer, the active energy ray curable emulsion being obtained by emulsifying polyfunctional monomer and active energy ray initiator with the emulsion stabilizer the same as that for the binder.

Photo resist layers of water dispersion types are known in the art, and are disclosed in, for example, U.S. Pat. No. 5,045,435, MRL. Bull. RES. DEV. Vol.2(2), pp.13-17 (1988), U.S. Pat. Nos. 5,501,942 and 5,691,006 (both corresponding to JP-A 5-009407), JP-A 9-157495 and JP-A 2000-267278.

Particles of high-molecular binder emulsion for producing the composition of the photo resist layer of the water dispersion type can be produced by emulsion polymerization of the above-described vinyl monomers in a condition of existence of the emulsifier.

Emulsifier used for the emulsion can be such types used in the ordinary emulsion polymerization. Examples of emulsifiers are anion emulsifiers, including dodecyl benzene sulfonate of sodium, dodecyl sulfate of sodium, dialkyl sulfo succinate of sodium, formalin condensates of naphthalene sulfonic acid, and polyoxyethylene alkyl phenyl ether sulfate ammonium salt; and nonionic emulsifiers, including polyoxyethylene nonyl phenyl ether, polyethylene glycol monostearate, and sorbitan monostearate.

Furthermore, the emulsifier in use can be polymerizable emulsifier which may be used singularly or in combination with the above-described anion emulsifiers or nonionic emulsifiers. The term of polymerizable emulsifier is used to mean emulsifier of which a molecule has at least one polymerizable functional group such as a (meth)allyl group, 1-propenyl group, 2-methyl-1-propenyl group, vinyl group, isopropenyl group, and (meth)acryloyl group. Among those, polymerizable emulsifier having (meth)acryloyl group as a polymerizable functional group is preferable in particular. Specific examples of the polymerizable emulsifiers include sulfo succinate esters of polyoxyethylene alkyl ether, sulfate esters of polyoxyethylene alkyl ether, sulfo succinate esters of polyoxyethylene alkyl phenyl ether, and sulfate esters of polyoxyethylene alkyl phenyl ether. Further examples of the polymerizable emulsifiers include acid phosphate esters of (meth)acrylic acid, phosphate esters of oligoester (meth)acrylate, or basic salts of the same, and oligoester poly(meth)acrylate of polyalkylene glycol derivatives having a hydrophilic alkylene oxide group. It is also possible to use high-molecular polymerizable emulsifier obtained by addition in which a compound having a glycidyl (meth)acrylate or other epoxy groups and an α,β-unsaturated double bond is added to a neutralized compound of (meth)acrylic copolymer having a tertiary amino group.

The above-described polymerizable emulsifier are copolymerized with vinyl monomers, and become contained in emulsion particles. This is effective in preventing occurrence of a free component of emulsifier which would cause foaming of the emulsion, lowering of the water resistance of the hardened film, or the like. Thus, it is preferable to use polymerizable emulsifier for the purpose of emulsification.

Examples of polymerizable emulsifiers having one polymerizable functional group per molecule are disclosed in JP-A 63-023725, U.S. Pat. No. 4,918,211 (corresponding to JP-A 63-240931), and JP-A 62-104802. Also, other preferable examples are KAYAMER PM-1 (trade name, manufactured by Nippon Kayaku Co., Ltd.), SE-1ON (trade name, manufactured by Asahi Denka Co., Ltd.), NE-10, NE-20 and NE-30 (trade names, manufactured by Asahi Denka Co., Ltd.), NEW FRONTIER N-117E (trade name, manufactured by Dai-ichi Kogyo Seiyaku Co., Ltd.), AKUARON RN-20 and AKUARON HS-10 (trade names, manufactured by Dai-ichi Kogyo Seiyaku Co., Ltd.), ELEMINOL JS-2 (trade name, manufactured by Sanyo Chemical Industries, Ltd.), and LATEMUL S-120 and LATEMUL S-180 (trade names, manufactured by Kao Corporation).

The types of emulsifiers can be selected in consideration of the diameter of the emulsion particles, stability, crosslink density, characteristics of the hardened films, and the like. A range of using the emulsifier relative to the total of the vinyl monomer is 0.1-80 wt. %, preferably 5-50 wt. %, and desirably 10-30 wt. %. It is to be noted that the stability in the dispersion of the emulsion particles is considerably low specifically if the average diameter of the emulsion particles to be produced is 100 nm or less. Thus, it is desirable to use 5 wt. % or more of the emulsifier.

The temperature in the emulsion polymerization is 50-95° C., and preferably 65-85° C. To determine the density in the emulsion polymerization, a ratio of the solid component including the vinyl monomer and the emulsifier is in a range of 10-90 wt. %, preferably 15-85 wt. %, and desirably 30-75 wt. %.

Types of polymerization initiators for use in the emulsion polymerization may be any type used generally in known emulsion polymerization. Examples of the polymerization initiators are water-soluble radical polymerization initiators such as: potassium persulfate, sodium persulfate, ammonium persulfate, and other persulfate salts, hydrogen peroxide, organic peroxides, and water-soluble azo compounds. Those can be used in a simple manner without being combined. Also, those can be combined as redox types of polymerization initiators in which the persulfate salts are combined with reducing agents, such as sodium bisulfite, sodium hydrogen thiosulfate, and ascorbic acid. An amount of the polymerization initiator relative to total of the vinyl monomer is preferably 0.005-5 mole %. In the case of producing crosslink emulsion particles by use of polymerizable emulsifier at as small an average particle diameter as 100 nm, it is preferable to use redox catalyst under a condition of existence of copper(II) ion or other suitable transition metal ion. Density of the transition metal ion in the reaction system is preferably in a range from 1.0×10⁻⁸ to 1.0×10⁻³ mole/liter.

According to the emulsion polymerization described heretofore, the emulsion particles having the average particle diameter of 0.05-500 microns can be obtained for being supplied with active energy ray curable compound.

According to the active energy ray curable emulsion of the present invention, each of the emulsion particles contains polyfunctional monomer and active energy ray initiator for photo polymerization.

Various methods can be used for bringing polyfunctional monomer and active energy ray initiator into emulsion particles. For example, a method disclosed in Journal of Dispersion Science & Technology, Volume 5, page 231 (1984) can be used, according to which emulsion particles are formed and used as core particles, polyfunctional monomer and active energy ray initiator are added to the core particles for simply effecting absorption and expansion. Also, the two-step swelling method disclosed in Macromolecule Chemistry, Volume 180, page 737 (1979) can be utilized. Furthermore, the molecule dispersion method, dynamic swelling method, and dispersion swelling method known in the art can be used for bringing polyfunctional monomer and active energy ray initiator.

A specifically preferable method is to disperse the polyfunctional monomer and active energy ray initiator as water dispersion, and to add and agitate emulsion particles in the water dispersion for mixture.

The water dispersion with the above-mentioned polyfunctional monomer and active energy ray initiator is adjusted with emulsifier at an intentionally small amount and at high density to lower the dispersing stability. This is to raise smoothness in bringing the polyfunctional monomer and active energy ray initiator into emulsion particles. The emulsifier used for this purpose can be any one among those described above. In particular, dodecyl benzene sulfonate of sodium is preferable as emulsifier. An amount of the emulsifier relative to the total of the polyfunctional monomer and active energy ray initiator is 10 wt. % or less, preferably 0.05-10 wt. %, and desirably 0.1-5 wt. %. Density of the water dispersion for mixture by addition and agitation is 5-90 wt. %, preferably 10-85 wt. %, and desirably 20-75 wt. %.

To add the water dispersion to the emulsion particles, it is possible to use any selected one of collective addition at one time, continuous addition, intermittent addition, and addition in a combined manner of two or more of those. The density of the emulsion particles at the time of adding the water dispersion is 10-50 wt. %, and preferably 15-35 wt. %. The temperature at the time of the addition is 20-70° C., and preferably 30-50° C.

Problems are likely to occur in that introduction of polyfunctional monomer and active energy ray initiator into emulsion particles does not proceed sufficiently. Stability in the dispersion becomes lower to create aggregation of emulsion mixture. Such a problem occurs typically when polyfunctional monomer and active energy ray initiator are introduced at 50 wt. % or more relative to the solid component of the emulsion particles, or when polyfunctional monomer and active energy ray initiator have low solubility to water. To promote the introduction of the additional compounds into the emulsion particles, it is effective to disperse the water dispersion of the additional compounds to a finer extent than the emulsion particles by use of homogenizer or the like before the introduction. Note that it is also possible to use a method of introducing a small amount of a compound with low water-solubility before introducing the polyfunctional monomer and active energy ray initiator by addition and agitation. A preferable compound with low solubility to water is 1-chloro dodecane as solvent. A method of introducing the compound with low solubility to water can be the same as that for introducing the polyfunctional monomer and active energy ray initiator to the emulsion particles. An amount of the compound with low solubility to water is 30 wt. % or less relative to the solid component of the emulsion particles, and preferably 1-30 wt. %, and desirably 5-20 wt. %.

The emulsion stabilizer should be used at an amount of 0.2-10 wt. % or less relative to the total of the solid component of the resin, and preferably 0.5-5 wt. %. Should the amount of the emulsion stabilizer be too low, it is likely that a diameter of emulsion particles is too large to lower stability of the emulsion. Should the amount be too high, it is likely that latitude in the development is insufficient for the reason described above. If the above-described water soluble high-molecular compound is used with the emulsion stabilizer, the water soluble high-molecular compound should be used at an amount equal to or less than the amount of the emulsion stabilizer, and preferably 50 wt. % or less. Should the water soluble high-molecular compound be more than the emulsion stabilizer, there occurs an unwanted influence to tightness in attachment of the resist film to the substrate, hardness, or the like.

Examples of emulsion stabilizers are hydrophilic or water-soluble high-molecular compounds formed by radical polymerization. To control the solubility to water and balance between the hydrophilic and hydrophobic characteristics, it is possible to change a ratio between hydrophilic and hydrophobic monomers, the hydrophilic monomers including carboxylic acid monomers. Examples of carboxylic acid monomers are (meth)acrylic acids, and addition products produced by reaction of hydroxy ethyl (meth)acrylates and anhydrides of acids. Examples of methods to provide emulsion stabilizer with a radical-polymerizable group include a method of addition of glycidyl methacrylate to the above-described carboxylic acid group, and a method of forming polymer having a hydroxy group, and then adding isocyanate ethyl methacrylate to the hydroxy group. Examples of hydrophilic monomers include polyethylene glycol macromer. Examples of hydrophobic monomers include styrene, and lauryl (meth)acrylate.

The emulsion stabilizer has a weight-average molecular weight of preferably 4,000-400,000, and desirably 8,000-20,000. Should the weight-average molecular weight be lower than 4,000, performance of stabilization may be too low in the course of the emulsification. Should the weight-average molecular weight be higher than 400,000, viscosity at the time of polymerization may be too high to cause extreme difficulties in the manufacture.

[Emulsion Particle Diameter]

The emulsion particles have an area-average diameter of preferably 0.1-5.0 microns, and desirably 0.3-1.5 microns. Should the diameter be shorter than 0.1 micron, a great amount of the emulsion stabilizer will be required. Should the diameter be too long, it is likely that settling or aggregation of emulsion particles will occur.

[Emulsion Solid Component Proportion]

The proportion of the solid component of the emulsion is preferably 20-90 wt. %, and desirably 35-75 wt. %. Should the proportion of the solid component be lower than 20 wt. %, the material cannot be transported in a very economized manner. Should the proportion of the solid component be higher than 90 wt. %, unwanted growth of emulsion particles may occur according to fusing between the particles.

[Production of the Dry Film Resist]

In FIG. 2, the dry film resist 10 of the present invention is illustrated. The dry film resist 10 includes a transparent support 11, and a first photo resist layer 14 and a second photo resist layer 15 formed from the above-described compositions and overlaid on the transparent support 11. For the photo resist layers 14 and 15, at first each of the compositions is dissolved in solvent or dispersed in water, to obtain coating liquid. The transparent support 11 is coated with the coating liquid, and dried, to form the photo resist layers. Also, a protective film 13 is laminated on the second photo resist layer 15 according to dry lamination.

A coating method for application of solution or dispersion of compositions for the photo resist layers is not limited. Examples of coating methods include a spraying method, roll coating method, rotational applying method, slit coating method, extrusion coating method, curtain coating method, die coating method, wire bar coating method, and knife coating method. A drying condition depends upon various components and a ratio of those, but can be at a temperature of 60-110° C. for a period nearly from 30 seconds to 15 minutes.

Examples of the solvents for the coating liquid include:

alcohols, such as methanol, ethanol, n-propanol, isopropanol, n-butanol, sec-butanol, and n-hexanol;

ketones, such as acetone, methyl ethyl ketone, methyl isobutyl ketone, cyclohexanone, and diisobutyl ketone;

esters, such as ethyl acetate, butyl acetate, n-amyl acetate, methyl sulfate, ethyl propionate, dimethyl phthalate, and ethyl benzoate;

aromatic hydrocarbons, such as toluene, xylene, benzene, and ethyl benzene;

halogenated hydrocarbons, such as carbon tetrachloride, trichloro ethylene, chloroform, 1,1,1-trichloro ethane, methylene chloride, and monochloro benzene;

ethers, such as tetrahydro furan, diethyl ether, ethylene glycol monomethyl ether, ethylene glycol monoethyl ether, and 1-methoxy-2-propanol;

other compounds, such as dimethyl formamide, and dimethyl sulfoxide.

[Support]

It is necessary for the transparent support 11 to have so high transparency that a great part of light can be transmitted. Also, the transparent support 11 must have a smooth surface. Examples of plastic films for the transparent support 11 include polyethylene terephthalate, polyethylene naphthalate, polypropylene, polyethylene, cellulose triacetate, cellulose diacetate, poly(meth)acrylate ester of alkyl, copolymer of poly(meth)acrylate ester, polyvinyl chloride, polyvinyl alcohol, polycarbonate, polystyrene, cellophane, copolymer of polyvinylidene chloride, polyamide, polyimide, copolymer of vinyl chloride and vinyl acetate, polytetrafluoro ethylene, and polytrifluoro ethylene. Furthermore, a combined material including two or more of those can be used. Among all of them, polyethylene terephthalate is specifically preferable.

A thickness of the transparent support 11 is 5-150 microns, and preferably 10-50 microns. The above-described photo resist layers are overlaid on the transparent support 11 at thicknesses suitable for quality of image to be recorded thereon. The first photo resist layer has a thickness of 1-100 microns, and preferably 2-30 microns. The second photo resist layer has a thickness of 3-100 microns, and preferably 5-30 microns.

[Protective Film]

In the dry film resist 10, the protective film 13 is disposed on the photo resist layers 14 and 15 over the transparent support 11. Material for the protective film 13 may be the same as that for the transparent support 11. Other examples of materials for the protective film 13 include paper, polyethylene, polypropylene, paper with a laminated layer of polyethylene or polypropylene, and the like. Among those, polyethylene is preferable in particular. The protective film 13 has a thickness of preferably 5-100 microns, and desirably 10-50 microns. Let A represent strength of adhesion between the first photo resist layer 14 and the transparent support 11. Let B represent strength of adhesion between the second photo resist layer 15 and the protective film 13. It is necessary to satisfy the condition A>B. Combinations of materials for the transparent support 11 and the protective film 13 include polyethylene terephthalate/polypropylene, polyethylene terephthalate/polyethylene, polyvinyl chloride/cellophane, polyimide/polypropylene, and the like. Instead of such different materials between the transparent support 11 and the protective film 13, it is possible to subject at least one of the transparent support 11 and the protective film 13 to the surface treatment, to satisfy the condition of adhesion.

Examples of surface treatments for the purpose of raising the strength of adhesion between the transparent support 11 and the first photo resist layer 14 are additional overlaying of an undercoat, corona discharge treatment, flame treatment, ultraviolet application treatment, high frequency application treatment, glow discharge treatment, active plasma application treatment, laser application treatment, and the like. Also, a static friction coefficient between the transparent support 11 and the protective film 13 is important. The static friction coefficient is preferably 0.3-1.4, and desirably 0.5-1.2. Should the coefficient be 0.3 or less, excessive slip will occur to create offsetting between turns when wound in a roll form. Should the coefficient be 1.4 or more, it will be highly difficult to wind the protective film 13 in a roll form.

It is possible to subject the protective film 13 to a surface treatment. The purpose of the surface treatment is to lower the force of adhesion to the first photo resist layer. An example of the surface treatment is to form an undercoat on the protective film 13 with polymer, such as polyorgano siloxane, polyolefin fluoride, polyfluoro ethylene, and polyvinyl alcohol. To form the undercoat, a coating liquid of any of those polymers is applied to the surface of the protective film 13, and then dried at 30-150° C., preferably 50-120° C. for 1-30 minutes.

[Production of Printed Circuit Board]

A printed circuit board producing method of producing a printed circuit board by use of the dry film resist 10 of the present invention is constituted by the following steps. A step of overlaying the dry film resist 10 on the laminate plate with heat applied thereto to cover the laminate plate entirely with the dry film resist 10, the laminate plate including an insulation substrate having through holes 18, and including a copper plating layer deposited on the insulation substrate on a whole surface thereof. A step of applying the active energy rays to a predetermined, portion of the through holes 18 in the laminate plate to harden the photo resist layers in the one ray-exposed portion, so as to impart alkali insolubility to the one ray-exposed portion of the photo resist layers, the predetermined portion being designated for being covered with the resist or designated for forming a wiring pattern. A step of eliminating an unexposed portion of the photo resist layers by use of aqueous solution of weak alkali to develop a photo resist pattern. A step of eliminating an uncovered portion of the copper plating layer from the insulation substrate by etching. A step of dissolving the developed photo resist pattern by use of aqueous solution of strong alkali.

In FIG. 5A, an insulation substrate 17 has a plurality of through holes. The whole of the surface of the insulation substrate 17 is plated with a copper plating layer 16, to constitute a laminate plate. The dry film resist 10 is used to form etching resist as illustrated in FIG. 5B. At first, the protective film 13 is peeled from the dry film resist 10. A roll of metal or rubber is heated at 60-120° C., and laminates the dry film resist 10 on the plate at a roll pressure of 2-5 kg/cm² and a lamination speed of 1-3 meters per minute. Note that in FIGS. 5A-5F, the first and second photo resist layers 14 and 15 are simplified as a single layer only for the purpose of understanding.

At the time of heating for the lamination, the fluidity of the second photo resist layer 15 is higher than the first photo resist layer 14. Viscosity of the second photo resist layer 15 is smaller by at least 10% than the first photo resist layer 14. Thus, the heat being applied melts the second photo resist layer 15 and causes the composition to flow into the through holes 18 by the virtue of the higher fluidity.

It is possible to suppress reduction in the film thickness on the periphery of the through hole 18, because the first photo resist layer has the lower fluidity at the time of heating. The dry film resist 10 is now described in comparison with the prior art. In FIG. 3, a dry film resist 1 of FIG. 1 of a single-layer structure in lamination is depicted in section. In FIG. 4, the dry film resist 10 of FIG. 2 of a two-layer structure is depicted according to the present invention. The film thickness on the periphery of the through hole 18 in the dry film resist 10 is expressed as (b′+c′). The film thickness on the periphery of the through hole 18 in the dry film resist 1 including a single photo resist layer 12 of the prior art is expressed as a′. As a result, b′+c′>a′ is satisfied. Consequently, reduction in the film thickness on the periphery of the through hole 18 can be suppressed in the present invention.

In FIG. 5C, a photo mask 20 with an aperture is set to apply ultraviolet rays 21 as active energy rays, to effect an exposure. Note that a laser exposing device may be used. Laser light as active energy rays is emitted at a wavelength of an ultraviolet region or visible region, and controlled in accordance with a pattern signal or information. Portions hardened by application of the energy rays comes to have a very small solubility to aqueous solution of weak alkali such as sodium carbonate. After the transparent support 11 is peeled, remaining unexposed portions are melted and removed by use of aqueous solution of weak alkali. In FIG. 5D, the etching resist of the tent form is formed in a shape to form a circuit pattern of the panel and to cover the through holes 18.

Then etching is effected by use of copper etching solution known in the art. The composition of the first photo resist layer comes into the through hole 18. The composition of the second photo resist layer closes the surface. Thus, the through hole 18 remains in the predetermined shape of FIG. 5E without entry of the etching solution into the through hole 18 or corrupt the copper plating in the through hole 18.

Then remaining composition of the photo resist layers on the panel surface and the inside of the through hole 18 is peeled and removed by use of aqueous solution of strong alkali such as sodium hydroxide or potassium hydroxide. In FIG. 5F, a printed circuit board with the through hole 18 is obtained.

When the thermal roll is operated to laminate the dry film resist 10 to the printed circuit board with the through hole 18, the second photo resist layer 15 is melted and flows into the through hole 18 because of its high fluidity upon being heated. Thus, the through hole 18 can be closed with the resin with necessary changes in specifics of the printed circuit board and the thickness of the resin layers. In contrast, the first photo resist layer 14 has smaller reduction in the film thickness because of lower fluidity. Consequently, the etching resist layers can be created with high tent strength.

### EXAMPLES

[Binder Emulsion 1]

A 2-liter separable flask was prepared, and was provided with a reflux pipe, a temperature adjustor, a nitrogen supply port, and an agitation impeller. The flask was supplied with ion exchange water at 45 parts by weight, ammonium persulfate at 0.3 part, and dodecyl benzene sulfonate of sodium at 2 parts, and kept at the temperature of 50° C. Then mixed liquid was poured into the flask, including methacrylic acid at 2.7 parts by weight, methyl methacrylate at 6.1 parts, 2-ethyl hexyl acrylate at 2.4 parts, benzyl methacrylate at 0.9 part, and dodecane thiol at 0.02 part. Heat was applied to raise the temperature to 70° C. After this, further mixed liquid was poured at a constant small speed for three (3) hours in a dropped manner. The further mixed liquid included methacrylic acid at 22.1 parts by weight, methyl methacrylate at 48.9 parts, 2-ethyl hexyl acrylate at 19.2 parts, benzyl methacrylate at 7 parts, and dodecane thiol at 0.18 part. The reaction was continued further for one hour, to obtain Binder emulsion 1. The density of the solid component of Binder emulsion 1 was 70 %. The acid value of the resin was 147 mgKOH per gram. A calculated value of glass transition temperature was 73° C. The weight-average molecular weight was 50,000.

[Binder Emulsion 2]

In a manner similar to Binder emulsion 1, copolymer of styrene and acrylic acid was produced as Binder emulsion 2 at a mole ratio of 63 mole % and 37 mole %. The density of the solid component of Binder emulsion 2 was 70 %. The acid value of the resin was 202 mgKOH per gram. A calculated value of glass transition temperature was 102° C. The weight-average molecular weight was 6,000.

### Example 1

The transparent support or polyethylene terephthalate film V-20 (trade name, manufactured by Teijin Ltd.) was prepared, and had a thickness of 20 microns. The film was coated with coating liquid of the composition for the first photo resist layer, and dried. This composition is indicated below. After being dried, the first photo resist layer was 15 microns thick. Then the first photo resist layer was coated with coating liquid of the composition for the second photo resist layer, and dried. After being dried, the second photo resist layer was 5 microns thick. Then the protective film GF106 (trade name, manufactured by Tamapoly Co., Ltd.) was overlaid to cover the second photo resist layer, to obtain the dry film resist. The first and second photo resist layers had viscosity of respectively 3×10⁵ Pa.s and 1×10⁵ Pa.s at the temperature of 80° C.

Composition of the Coating Liquid for the 1^{st} Photo Resist Layer]

Solution of 35 wt. % of copolymer of methacrylic acid, methyl methacrylate, 2-ethyl hexyl acrylate, and benzyl methacrylate, with a copolymerization ratio of 28.8 mole %, 55 mole %, 11.7 mole % and 4.5 mole %, weight-average molecular weight of 80,000, in solvent of methyl ethyl ketone and 1-methoxy-2-propanol, as mixture at a weight ratio of 2/1, produced by solution polymerization; 17.19 parts

Solution of 35 wt. % of copolymer of styrene and acrylic acid, with a copolymerization ratio of 73 mole % and 37 mole %, weight-average molecular weight of 10,000, in solvent of methyl ethyl ketone and 1-methoxy-2-propanol, as mixture at a weight ratio of 2/1, produced by solution polymerization; 18.02 parts

dodeca propylene glycol diacrylate (ARONIX M270, trade name, manufactured by Toagosei Co., Ltd.); 4.7 parts

tetra ethylene glycol dimethacrylate (NK ester 4G, trade name, manufactured by Shin-nakamura Chemical Corp.); 1.08 parts

polyethylene glycol #400 diacrylate (NK ester A-400, trade name, manufactured by Shin-nakamura Chemical Corp.); 1.93 parts

N,N-diethyl amino benzophenone; 0.04 part

benzophenone; 1.0 part

2-(o-chloro phenyl)-4,5-diphenyl imidazole dimer; 1.0 part

tribromo methyl phenyl sulfone; 0.15 part

leuco crystal violet; 0.2 part

malachite green oxalate; 0.016 part

1,2,4-triazole; 0.02 part

p-toluene sulfonamide; 0.5 part

methyl ethyl ketone; 9.3 parts

1-methoxy-2-propanol; 4.7 parts

[Composition of the Coating Liquid for the 2^{nd} Photo Resist Layer]

The following components were prepared, and agitated and mixed in a homogenizer for 10 minutes by 10,000 rotations.

Emulsion liquid the same as Binder emulsion 1 above, namely emulsion liquid of copolymer of methacrylic acid, methyl methacrylate, 2-ethyl hexyl acrylate, and benzyl methacrylate, with a copolymerization ratio of 28.8 mole %, 55 mole %, 11.7 mole % and 4.5 mole %, weight-average molecular weight of 50,000, with density of solid component of 70%; 17.16 parts

Emulsion liquid the same as Binder emulsion 2 above, namely emulsion liquid of copolymer of styrene and acrylic acid, with a copolymerization ratio of 63 mole % and 37 mole %, weight-average molecular weight of 6,000, with density of solid component of 70%; 18.02 parts dodeca propylene glycol diacrylate (ARONIX M277, trade name, manufactured by Toagosei Co., Ltd.); 4.7 parts

tetra ethylene glycol dimethacrylate (NK ester 4G, trade name, manufactured by Shin-nakamura Chemical Corp.); 1.08 parts

polyethylene glycol #400 diacrylate (NK ester A-400, trade name, manufactured by Shin-nakamura Chemical Corp.); 1.93 parts

N,N-diethyl amino benzophenone; 0.04 part

benzophenone; 1.0 part

2-(o-chloro phenyl)-4,5-diphenyl imidazole dimer; 1.0 part

tribromo methyl phenyl sulfone; 0.15 part

leuco crystal violet; 0.2 part

malachite green oxalate; 0.016 part

1,2,4-triazole; 0.02 part

p-toluene sulfonamide; 0.5 part

methyl ethyl ketone; 9.3 parts

1-methoxy-2-propanol; 4.7 parts

### Comparative Example 1

Only coating liquid of the first photo resist layer of Example 1 was applied to the support, to form a photo resist layer with a thickness of 20 microns, so a dry film resist was produced. Features other than this were the same as Example 1.

### Comparative Example 2

Only coating liquid of the second photo resist layer of Example 1 was applied to the support, to form a photo resist layer with a thickness of 20 microns, so a dry film resist was produced. Features other than this were the same as Example 1.

[Evaluation of Resolution and Tent Strength]

At first, a copper-plated laminate plate (NATIONAL copper-clad laminate R-1701 for printed circuit board, trade name, manufactured by Matsushita Electric Works, Ltd.), which had 1,200 through holes with a diameter of 6 mm, was prepared. The copper-plated laminate plate was polished and dried. The dry film resist, from which the protective film had been peeled, was fitted on the copper-plated laminate plate by opposing the second photo resist layer on the copper surface. A laminator (Model 8B-720-PH, trade name, manufactured by Taisei Laminator Co., Ltd.) was used to laminate the dry film resist on the copper-plated laminate plate. To condition the laminating operation, the substrate temperature was 70° C. The lamination temperature was 105° C. The lamination pressure was 3 kg/cm². The lamination feeding speed was 1.2 meters per minute.

After the laminating operation, the composite plate was left to stand for 10 minute at a room temperature of 23° C. and humidity of 55 % RH. Then active energy rays were applied through an original of negative to the composite plate of the dry film resist and the copper-plated laminate plate at energy of 50 mJ/cm² by use of a super-high-pressure mercury lamp. The original of the negative had patterns of various resolutions and attachment shapes, including a pattern with a line-to-space ratio of 1/1 at a size of 10-100 microns, and a pattern with a line-to-space ratio of 1/3 at a size of 10-100 microns.

After the exposure, the composite plate was left to stand at a room temperature for 10 minutes. Then the polyethylene terephthalate film was peeled away from the composite plate. Aqueous solution of 1 % of sodium carbonate was sprayed on the surface of the photo resist layer at 30° C. with a spraying pressure of 1.0 kg/cm² for 80 seconds. Thus, an unexposed portion was eliminated, before development was effected.

The composite plate was washed with water at the temperature of 20° C., a spraying pressure of 1.0 kg/cm² for 80 seconds. The composite plate was scratched by a hard rubber disk with load of 100 gf at a speed of 1 cm/sec. The hard rubber disk was formed from Viton rubber, had rubber hardness of 80, a diameter of 50 mm and thickness of 2 mm. Immediately, the composite plate was etched at the temperature of 45° C., a spraying pressure of 2.0 kg/cm² for 60 seconds with etching liquid of copper(II) chloride. The resist was peeled with aqueous solution of 2% of NaOH, to obtain the circuit board of copper.

The pattern with a line-to-space ratio of 1/1 was evaluated for resolution. The pattern with a line-to-space ratio of 1/3 was evaluated for tightness of the attachment after being etched. To evaluate the tent strength of the film, the dry film resist was laminated to the plate with numerous through holes. Numbers of the holes where the tent was broken in first, second and third conditions were counted. Holes counted in the first condition (1) were those where the tent was broken after the support had been peeled before the development. Holes counted in the second condition (2) were those where the tent was broken after the pattern had been exposed and developed with the support kept without removal. Holes counted in the third condition (3) were those where the tent was broken after the pattern had been exposed, developed and etched with the support kept without removal. The results are indicated in the table below.

| | | | Comp. | Comp. |
|---|---|---|---|---|
| | | Example 1 | Example 1 | Example 2 |
| Highest resolution | | 15 microns | 20 microns | 15 microns |
| Highest tightness of | | 15 microns | 30 microns | 15 microns |
| attachment | | | | |
| No. of | Condition | 0 | 0 | 2 |
| holes with | (1) | | | |
| broken | | | | |
| tent | | | | |
| | Condition | 0 | 0 | 3 |
| | (2) | | | |
| | Condition | 0 | 0 | 5 |
| | (3) | | | |

### Example 2 with Laser Exposure

A laser exposing device was used, in which violet laser light was emitted at 405 nm. A flexible laminate plate with two copper-plated surfaces was prepared, and had through holes with a diameter of 3 mm. The surfaces was polished and dried. Active energy ray initiator for photo polymerization was basically the same as Example 1 but that in which the N,N-diethyl amino benzophenone, benzophenone, 2-(o-chloro phenyl)-4,5-diphenyl imidazole dimer, and tribromo methyl phenyl sulfone being included in that according to Example 1 were replaced by 2-(p-styryl)-styryl-5-trichloro methyl-1,3,4-oxa diazol at 0.3 part by weight. Other features were the same as Example 1 in the dry film resist. Two dry film resists were fitted on both surfaces of a flexible sample, before the sample was wound on a drum of the laser exposing device, and exposed in a condition of 20 mJ/cm2. The sample was developed by use of aqueous solution of 1% of sodium carbonate at 30° C. for 20 seconds, and etched by use of etchant of copper chloride. After this, the dry film resists were removed by use of aqueous solution of 2% of potassium hydroxide. As a result, the highest resolution was 20 microns. The highest tightness in the attachment was 20 microns. No breakage of the tent was discovered before the development, after the development and after the etching.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A dry film resist comprising:
a support;
first and second photo resist layers, disposed on said support, developable in alkaline development, and sensitive to active energy rays;
said first photo resist layer being overlaid on said support;
said second photo resist layer being overlaid on said first photo resist by application in a state of water dispersion emulsion; and
a protective film overlaid on said second photo resist layer in a peelable manner.

2. A dry film resist as defined in claim 1, wherein said second photo resist layer has a higher fluidity than said first photo resist layer at a time of heating for lamination to a substrate.

3. A dry film resist as defined in claim 2, wherein viscosity of said second photo resist layer is smaller by at least 10% than viscosity of said first photo resist layer at said heating time for said lamination.

4. A dry film resist as defined in claim 3, wherein said first and second photo resist layers have viscosity of 10⁴-10⁶ Pa.s at 60-120° C.

5. A dry film resist as defined in claim 3, wherein said support has a thickness of 5-150 microns, said first photo resist layer has a thickness of 1-100 microns, and said second photo resist layer has a thickness of 3-100 microns.

6. A dry film resist as defined in claim 3, wherein said first photo resist layer includes:
first binder, soluble in aqueous solution of alkali, and obtained by solution polymerization; and
first polyfunctional monomer and first active energy ray initiator;
said second photo resist layer is formed after drying of coating liquid constituting said first photo resist layer, and includes:
second binder of emulsion, soluble in aqueous solution of alkali, and obtained by emulsion polymerization; and
second polyfunctional monomer and second active energy ray initiator, mixed in a form of water dispersion with said second binder.

7. A dry film resist as defined in claim 6, wherein each of said first and second polyfunctional monomers contains two or more ethylenically unsaturated bonds, and is photo polymerizable in response to said active energy rays.

8. A dry film resist as defined in claim 6, wherein each of said first and second active energy ray initiators includes at least one of derivative of halogenated hydrocarbon, ketone compound, ketoxime compound, organic peroxide, thio compound, hexaaryl biimidazole, aromatic onium salt, and ketoxime ether.

9. A dry film resist as defined in claim 6, wherein said second photo resist layer further includes emulsifier for said emulsion polymerization of said second binder.

10. A dry film resist as defined in claim 9, wherein said emulsifier includes at least one of anion emulsifier, nonionic emulsifier, and polymerizable emulsifier that has a polymerizable functional group.

11. A printed circuit board producing method in which a dry film resist is used, said dry film resist including:
a support;
first and second photo resist layers, disposed on said support, developable in alkaline development, and sensitive to active energy rays;
said first photo resist layer being overlaid on said support;
said second photo resist layer being overlaid on said first photo resist by application in a state of water dispersion emulsion; and
a protective film overlaid on said second photo resist layer in a peelable manner;
said printed circuit board producing method comprising steps of:
supplying a laminate plate including an insulation substrate, plural through holes formed in said insulation substrate, and a copper plating layer overlaid on said insulation substrate;
peeling said protective film from said dry film resist;
laminating and heating said dry film resist and said laminate plate by opposing said second photo resist layer of said dry film resist to said laminate plate;
applying said active energy rays to said dry film resist according to pattern information, said pattern information being associated with a portion for being covered among said through holes and a portion for forming a circuit pattern among said through holes, so as to expose a first portion in said first and second photo resist layers, said first portion being hardened and becoming insoluble to alkali;
eliminating a portion of said first and second photo resist layers different from said first portion from said laminate plate by dissolution in aqueous solution of weak alkali;
eliminating said copper plating layer from a periphery of said first portion in said insulation substrate by etching; and
eliminating said first portion from said insulation substrate by dissolution in aqueous solution of strong alkali, to obtain a covered portion and said circuit pattern of said copper plating layer among said through holes.

12. A printed circuit board producing method as defined in claim 11, wherein said second photo resist layer has a higher fluidity than said first photo resist layer in said laminating and heating step.

13. A printed circuit board producing method as defined in claim 12, wherein viscosity of said second photo resist layer is smaller by at least 10% than viscosity of said first photo resist layer in said laminating and heating step.

14. A printed circuit board producing method as defined in, claim 13, wherein said first and second photo resist layers have viscosity of 10⁴-10⁶ Pa.s at 60-120° C.

15. A printed circuit board producing method as defined in claim 13, wherein said support has a thickness of 5-150 microns, said first photo resist layer has a thickness of 1-100 microns, and said second photo resist layer has a thickness of 3-100 microns.

16. A printed circuit board producing method as defined in claim 13, wherein said active energy rays are ultraviolet or visible;
in said applying step, a photo mask is used through which said active energy rays are applied, said photo mask has an aperture for constituting said pattern information to form said first portion in said dry film resist.

17. A printed circuit board producing method as defined in claim 13, wherein said active energy rays are laser light, and in said applying step, said laser light is caused to scan said dry film resist according to said pattern information.

18. A printed circuit board producing method as defined in claim 13, wherein said first photo resist layer includes:
first binder, soluble in aqueous solution of alkali, and obtained by solution polymerization; and
first polyfunctional monomer and first active energy ray initiator;
said second photo resist layer is formed after drying of coating liquid constituting said first photo resist layer, and includes:
second binder of emulsion, soluble in aqueous solution of alkali, and obtained by emulsion polymerization; and
second polyfunctional monomer and second active energy ray initiator, mixed in a form of water dispersion with said second binder.

19. A printed circuit board producing method as defined in claim 18, wherein each of said first and second polyfunctional monomers contains two or more ethylenically unsaturated bonds, and is photo polymerizable in response to said active energy rays.

20. A printed circuit board producing method as defined in claim 18, wherein each of said first and second active energy ray initiators includes at least one of derivative of halogenated hydrocarbon, ketone compound, ketoxime compound, organic peroxide, thio compound, hexaaryl biimidazole, aromatic onium salt, and ketoxime ether.

21. A printed circuit board producing method as defined in claim 18, wherein said second photo resist layer further includes emulsifier for said emulsion polymerization of said second binder.

22. A printed circuit board producing method as defined in claim 21, wherein said emulsifier includes at least one of anion emulsifier, nonionic emulsifier, and polymerizable emulsifier that has a polymerizable functional group.
